(19) United States
(12) Patent Application Publication
(10) Pub. No.: US 2022/0041898 A1
(43) Pub. Date: Feb. 10, 2022

(54) LOW MODULUS, HIGH ELONGATION STRUCTURAL ADHESIVES AND ASSOCIATED BONDED SUBSTRATES

(71) Applicants: Thanikaivelan Tindivanam Veeraraghavan, Newburgh, IN (US); Ramanathan Lakshminarayan, Newburgh, IN (US); Brandon Allen Willis, Newburgh, IN (US)

(72) Inventors: Thanikaivelan Tindivanam Veeraraghavan, Newburgh, IN (US); Ramanathan Lakshminarayan, Newburgh, IN (US); Brandon Allen Willis, Newburgh, IN (US)

(21) Appl. No.: 16/986,434

(22) Filed: Aug. 6, 2020

(51) Int. Cl. C09J 7/35; C09J 163/00; C09J 175/04; C08K 5/315

(52) U.S. Cl. CPC C09J 7/35; C09J 163/00; C09J 175/04; C09J 2301/304; C09J 2475/00; C09J 2463/00; C08K 5/3155

(57) ABSTRACT

A substrate assembly, including: (a) a first substrate; (b) a second substrate; and (c) a thermosetting adhesive associated with at least a portion of the first and second substrates, wherein the thermosetting adhesive includes a curing agent, and an epoxy-modified dimerized fatty acid combined with an epoxy terminated polyurethane interpenetrating network.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to structural adhesives, and, more particularly, to low modulus, high elongation structural adhesives that utilize epoxy-modified dimerized fatty acids combined with an epoxy terminated polyurethane interpenetrating network (IPN). The structural adhesives of the present invention are suitable for use in bonding similar and/or dissimilar substrates.

### 2. Background Art

Adhesives have been known in the art for years and are the subject of a plurality of patents and/or publications, including: U.S. Pat. No. 9,394,468 entitled “Structural Adhesives,” U.S. Pat. No. 5,290,857 entitled “Epoxy Resin Adhesive Composition,” U.S. Pat. No. 4,983,672 entitled “Epoxide Resin Compositions and Method,” U.S. Pat. No. 4,574,142 entitled “Curable Adhesive Composition Toughened with Styrene-Butadiene Block Copolymer Rubbers,” United States Patent Application Publication No. 2015/0045510 entitled “Epoxy Adhesive, Manufacture and Use Thereof,” International Patent Publication No. WO 2009/124709 entitled “Improvements in or Relating to Structural Adhesives,” International Patent Publication No. WO 2008/157129 entitled “Toughened Adhesive Material,” and European Patent No. 2,739,690 entitled “Electrically Conductive Structural Adhesive”—all of which are hereby incorporated herein by reference in their entirety including the references cited therein.

U.S. Pat. No. 9,394,468 appears to disclose a thermohardenable structural adhesive material that upon curing has an elongation at break of at least 10% and has a glass transition temperature (Tg) of 80° C. or higher and is useful as a structural adhesive in automobiles to reduce the deformation of bonds particularly during accidents, the adhesive is dry to the touch at ambient temperature and can be melt processed at temperature below that at which thermohardening occurs. The adhesives are useful in applications requiring a combination of high strain to failure, glass transition temperature more than 80° C., high stiffness and high strength. This combination is of particular interest in the aerospace and automotive industries.

U.S. Pat. No. 5,290,857 appears to disclose an epoxy resin adhesive composition that has excellent adhesive properties such as impact resistance, tensile shear strength and T-peel strength as well as excellent semi-gelling property. An epoxy resin adhesive composition comprising ionic crosslinking in a polymer utilized as the impact resistance modifier has not only excellent semi-gelling property and mechanical properties of cured products but also excellent storage stability for a long time and it is advantageously utilized when the application occasionally requires storage or standing of the material for one month to one year at the room temperature. The epoxy resin adhesive composition comprises an epoxy resin, a powder core/shell polymer and a heat activation type hardener for epoxy resins. The powder core/shell polymer is composed of a core comprising an acrylate polymer or a methacrylate polymer having a glass transition temperature of −30° C. or lower and a shell comprising an acrylate polymer or a methacrylate polymer comprising crosslinking monomer units having a glass transition temperature of 70° C. or higher and weight ratio of the core to the shell is in the range from 10/1 to 1/4.

U.S. Pat. No. 4,983,672 appears to disclose a method of improving epoxy resin compositions that provides a cured resin having improved glass transition temperature and toughness characteristics. The method includes providing in an epoxy resin composition an effective amount of a 9,9-bis(hydroxphenyl)fluorene composition. The fluorene component acts as a chain extension agent and provides for increased glass transition temperature and less cross-link density. As a result, improved toughness occurs. In preferred applications a toughening agent is provided in the resin composition, to further enhance toughness. Preferred resin compositions, cured resins and methods of providing improved cured resins are also provided.

U.S. Pat. No. 4,574,142 appears to disclose elastomer toughened two-part acrylic monomer adhesives which employ styrene-butadiene block copolymer rubbers as the elastomer have improved heat resistance properties at temperatures typical of industrial paint bake ovens. The adhesives include: in one part an acrylic monomer, at least 33% by weight of the rubber dissolved in the monomer, and a free radical catalyst system free of organic sulfonyl chloride; and in the other part a polymerization activator such as an amine-aldehyde condensation product.

United States Patent Application Publication No. 2015/0045510 appears to disclose an epoxy adhesive that simultaneously has low E-modulus and high glass temperature. Such adhesives are useful in the manufacture of large machinery (e.g., automobiles), and are useful for bonding different materials, such as metal and carbon fiber composite. The cured epoxy adhesive can be formulated to have an E-modulus of less than 1000 MPa, and a glass transition temperature of at least 80° C. The epoxy adhesive comprises a capped polyurethane pre polymer, a core shell rubber, and polyetheramine-epoxy adduct.

International Patent Publication No. WO 2009/124709 appears to disclose an adhesive formulation comprising i) an adduct of an epoxy resin and an elastomer; ii) a phenoxy resin; iii) a core/shell polymer; iv) a curing agent that provides a structural adhesive with improved low temperature impact strength particularly useful for bonding metal especially in the automotive industry.

International Patent Publication No. WO 2008/157129 appears to disclose an adhesive material and articles incorporating the same. The adhesive material includes at least three of epoxy resin; impact modifier; flexibilizer, blowing agent; curing agent; and filler. The adhesive material is preferably used for structural adhesion but may be used for sealing, baffling or reinforcing an article of manufacture such as an automotive vehicle.

European Patent No. 2,739,690 appears to disclose a two-part curable composition comprising: a. a first part comprising: i. at least one (meth)acrylate monomer; ii. an electrically conductive component; iii. an acid catalyst; iv. a free radical initiator; and v. a free radical stabilizer; wherein said electrically conductive component comprises synthetic graphite, wherein said graphite comprises synthetic graphite having a surface area of 20 m²/g to 24 m²/g, wherein said graphite is present in an amount of 10% to 15% by weight of said first part or wherein said graphite comprises graphite having a surface area of 17 m²/g to 20 m²/g, wherein said graphite is present in an amount of 15% to 20% by weight of said first part; and b. a second part comprising: i. at least one (meth)acrylate monomer; ii. a catalyst; and iii. a stabilizer for stabilizing said catalyst; wherein said first part and said second part are combined together to form a curable composition.

While the above-identified references, appear to disclose a plurality of structural adhesives, none of the above-identified references disclose low modulus, high elongation structural adhesives that utilize epoxy-modified dimerized fatty acids combined with an epoxy terminated polyurethane interpenetrating network (IPN) as disclosed herein.

It is therefore an object of the present invention to provide new, useful, and nonobvious structural adhesives having low modulus and high elongation characteristics for both similar and dissimilar substrate bonding applications.

These and other objects of the present invention will become apparent in light of the present specification, claims, and drawings.

### SUMMARY OF THE INVENTION

The present invention is directed to, in one embodiment, a unique epoxy hybrid structural heat curable adhesive that has been formulated based on epoxy-modified dimerized fatty acids combined with an epoxy terminated polyurethane interpenetrating network (IPN) and a standard liquid diglycidylether of bisphenol-A. The cured mechanical properties of the adhesives of the present invention are superior to conventional high rigid epoxy adhesives in OEM bonding applications of similar and dissimilar substrates. Due to the extremely low modulus and high elongation, the adhesive absorbs energy produced during distortion of similar or dissimilar or softer metal which occurs, for example, during an e-coat oven curing process and/or any dynamic climate condition.

It will be understood that controlling the movement of bonded metal parts depends, in large measure, on the properties of the adhesives used. Common issues include both shrinkage during cure and expansion during thermal excursions.

It will be further understood that all unstressed materials typically expand and contract with temperature. The coefficient of thermal expansion (CTE) is proportionality constant and assumes a linear increase in expansion for a linear increase in temperature. If a material undergoes a phase change, then movement is no longer linear. Metal substrates have more than one solid phase depending on the temperature. The CTE of organic polymers is much higher than other materials. Thus, as the temperature increases, the polymer is expected to expand much more than the metal substrates. To minimize motion and thermal alignment problems, polymers with a lower than normal CTE have been used. Polymers are often defined by two phases. A rigid crystalline phase and a rubbery elastic phase. Each phase has its own CTE. The CTE for the crystalline phase is called “alpha 1” and elastic phase is called “alpha 2”. The temperature between these two phases is called the glass transition temperature (Tg). Polymers undergo non-linear motion in the glass transition temperature region. This is a reversible phase change because no chemical bonds are broken in going from the crystalline to the elastic phase.

The uniquely formulated adhesives of the present invention have the lowest modulus and highest elongation seen heretofore that helps to increase the coefficient of linear thermal expansion (CLTE) which, in turn, helps to absorb bonded substrates movement during cure, as wells any dynamic climate conditions.

In one embodiment, the present invention is directed to a substrate assembly comprising: (a) a first substrate; (b) a second substrate; and (c) a thermosetting adhesive associated with at least a portion of the first and second substrates, wherein the thermosetting adhesive includes: (1) a curing agent, and (2) an epoxy-modified dimerized fatty acid combined with an epoxy terminated polyurethane interpenetrating network.

In a preferred embodiment of the present invention, the first substrate and the second substrate comprise similar metals. In this embodiment, the first and second substrates preferably range in thickness from approximately 0.25 millimeters (mm) to approximately 5.00 mm, and more preferably range in thickness from approximately 0.75 mm to approximately 2.50 mm.

In another preferred embodiment of the present invention, the first substrate and the second substrate comprise dissimilar metals. In this embodiment, the first and second substrates preferably range in thickness from approximately 0.25 mm to approximately 5.00 mm, and more preferably range in thickness from approximately 0.75 mm to approximately 2.50 mm.

In one aspect of the present invention, the first substrate and the second substrate independently comprise at least one of steel, steel electrogalvanized with zinc, steel hot dipped galvanized with zinc, aluminum, metal alloys, d-block metals, and combinations thereof.

In yet another preferred embodiment, the curing agent comprises a boron trifluoride-amine complex, an organic-acid hydrazide, and/or dicyandiamide.

In a preferred embodiment of the present invention, the curing agent is represented by at least one of the following tautomeric chemical structures:

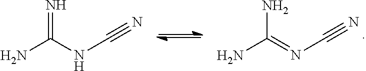 [SMILES: N#CNC(=N)N ; N#CN=C(N)N]

In another preferred embodiment of the present invention, the curing agent is represented by the following chemical structure:

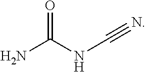

In a preferred embodiment of the present invention, the epoxy-modified dimerized fatty acid is represented by the following chemical structure:

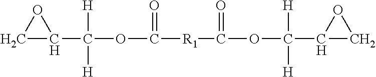

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 40 carbon atoms.

In another preferred embodiment of the present invention, the epoxy-modified dimerized fatty acid is represented by the following chemical structure:

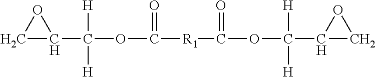

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 35 to approximately 40 carbon atoms.

In yet another preferred embodiment of the present invention, the epoxy-modified dimerized fatty acid is represented by the following chemical structure:

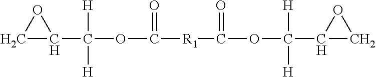

wherein R₁ is tall oil based.

In another aspect of the present invention, the epoxy terminated polyurethane interpenetrating network is represented by the following chemical structure:

A₁-R₁-A₂

wherein A₁ is represented by the following chemical structure:

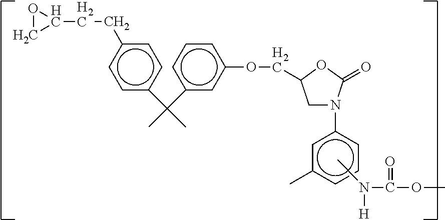

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 75 carbon atoms, an oligomer, and/or a polymer; and wherein A₂=A₁ or comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 35 carbon atoms, an oligomer, and/or a polymer.

In a preferred embodiment of the present invention, the epoxy terminated polyurethane interpenetrating network is represented by the following chemical structure:

A₁-R₁-A₂

wherein A₁ is represented by the following chemical structure:

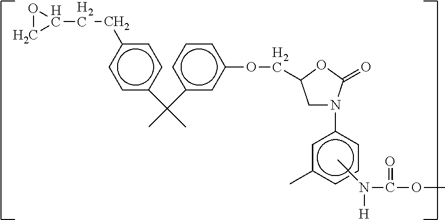

wherein R₁ comprises an alkyl, alkenyl, and/or alkynyl group containing approximately 1 to approximately 35 carbon atoms, an oligomer, and/or a urethane polymer; and wherein A₂=A₁.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 is a perspective view of an automobile having two dissimilar substrates secured together with an adhesive of the present invention;

FIG. 2 is a perspective view of a substrate assembly fabricated in accordance with the present invention showing bond and load lines;

FIG. 3 of the drawings is a cross-sectional schematic representation of a substrate assembly fabricated in accordance with the present invention;

FIG. 4 of the drawings is a two-dimensional plot showing deflection as a function of load for Example 3 (similar substrate/low bake);

FIG. 5 of the drawings is a two-dimensional plot showing deflection as a function of load for Example 3 (similar substrate/high bake);

FIG. 6 of the drawings is a two-dimensional plot showing deflection as a function of load for Example 3 (dissimilar substrate/low bake);

FIG. 7 of the drawings is a two-dimensional plot showing deflection as a function of load for Example 3 (dissimilar substrate/high bake);

FIG. 8 of the drawings is a two-dimensional CLTE plot showing dimension change as a function of temperature for Example 6 (1^{st} heating); and

FIG. 9 of the drawings is a two-dimensional CLTE plot showing dimension change as a function of temperature for Example 6 (2^{nd} heating);

FIG. 10 of the drawings is a ¹H-NMR spectrogram of a first tautomer of a curing agent;

FIG. 11 of the drawings is a ¹³C-NMR spectrogram of a first tautomer of a curing agent;

FIG. 12 of the drawings is a ¹H-NMR spectrogram of a second tautomer of a curing agent;

FIG. 13 of the drawings is a ¹³C-NMR spectrogram of a second tautomer of a curing agent;

FIG. 14 of the drawings is a ¹H-NMR spectrogram of a curing agent;

FIG. 15 of the drawings is a ¹³C-NMR spectrogram of a curing agent;

FIG. 16 of the drawings is a ¹H-NMR spectrogram of an epoxy-modified dimerized fatty acid curing agent;

FIG. 17 of the drawings is a ¹³C-NMR spectrogram of an epoxy-modified dimerized fatty acid curing agent;

FIG. 18 of the drawings is a ¹H-NMR spectrogram of an A₁ moiety; and

FIG. 19 of the drawings is a ¹³C-NMR spectrogram of an A₁ moiety.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

As will be discussed and shown experimentally hereinbelow, the present invention is directed to unique epoxy hybrid structural heat curable adhesives that have been formulated based on epoxy-modified dimerized fatty acids combined with an epoxy terminated polyurethane interpenetrating network (IPN) and a standard liquid diglycidylether of bisphenol-A. The cured mechanical properties of the adhesives of the present invention are superior to conventional high rigid epoxy adhesives in OEM bonding applications of similar and dissimilar substrates.

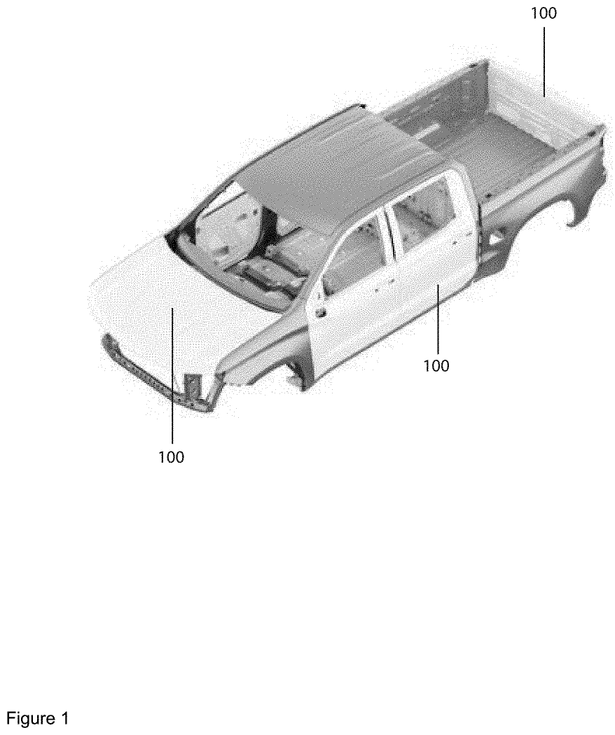

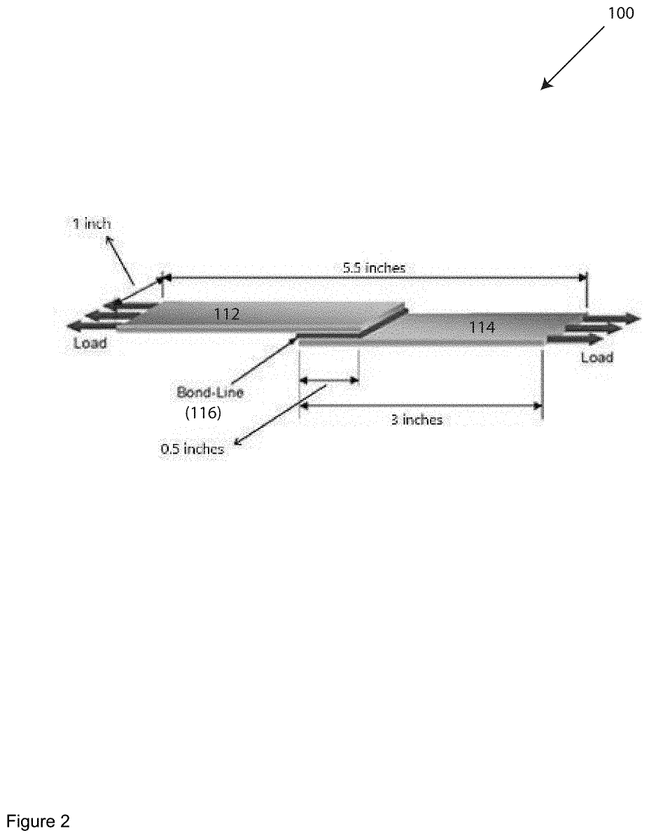

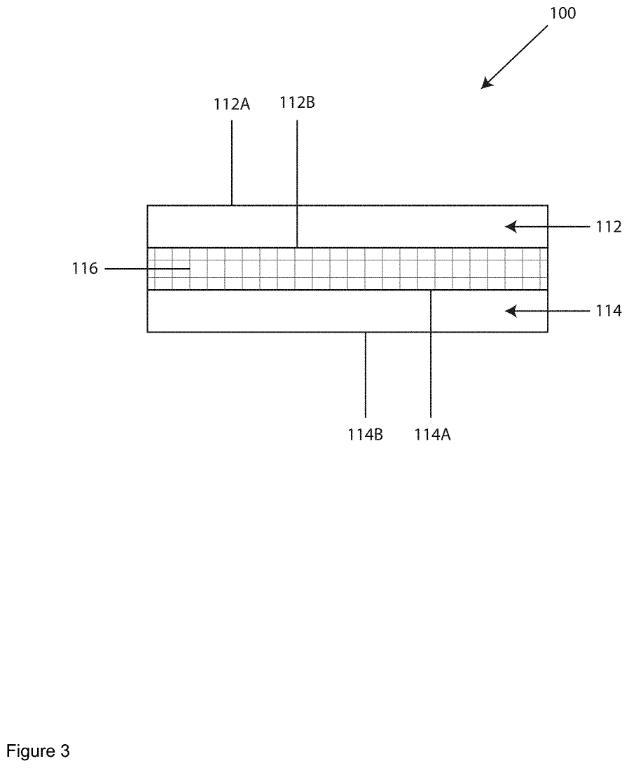

Referring now to the drawings and to FIGS. 1-3 in particular, substrate assembly 100 is shown, which generally comprises first substrate 112 having first surface 112A and second surface 112B, second substrate 114 having first surface 114A and second surface 114B, and adhesive 116. It will be understood that substrate assembly 100 may comprise, for illustrative purposes only, an automobile component (See FIG. 1), and the like. It will be further understood that FIGS. 2-3 are merely schematic representations of substrate assembly 100. As such, some of the components have been distorted from their actual scale for pictorial clarity.

First substrate 112 may be fabricated from any one of a number of materials, such as, for example, steel, steel electrogalvanized with zinc, steel hot dipped galvanized with zinc, aluminum, metal alloys, d-block metals, and combinations thereof. First substrate 112 may also be fabricated from, for example, borosilicate glass, soda lime glass, float glass, natural and synthetic polymeric resins, plastics, and/or composites including Topas®, which is commercially available from Ticona of Summit, N.J. First substrate 112 is preferably fabricated from a sheet having a thickness ranging from approximately 0.25 mm to approximately 5.00 mm, and more preferably ranging from approximately 0.75 mm to approximately 2.50 mm. Of course, the thickness of the substrate will depend largely upon the particular application of the assembly. While particular substrate materials have been disclosed, for illustrative purposes only, it will be understood that numerous other substrate materials are likewise contemplated for use—so long as the materials exhibit appropriate physical properties, such as strength, to be able to operate effectively in conditions of intended use. Indeed, substrate assemblies in accordance with the present invention can be, during normal operation, exposed to extreme temperature variation, as well as substantial UV radiation, emanating primarily from the sun.

Second substrate 114 may be fabricated from similar and/or dissimilar materials as that of first substrate 112. As such, second substrate 114 may comprise polymers, metals, glass, and ceramics—to name a few. Second substrate 114 is preferably fabricated from a sheet having a thickness ranging from approximately 0.25 mm to approximately 5.00 mm, and more preferably ranging from approximately 0.75 mm to approximately 2.50 mm.

The present invention is directed to a substrate assembly that includes: (a) first substrate 112; and second substrate 114 bonded together by adhesive 116. Adhesive 116 is preferably a thermosetting adhesive that is associated (e.g., applied, impregnated, etch coated, dip coated, spin coated, brush coated and/or spray coated) with at least a portion of first and second substrates 112 and 114, respectively. Preferably, the thermosetting adhesive includes a curing agent (e.g., aliphatic curing agents, cycloaliphatic curing agents, polyamide curing agents, amidoamine curing agents, waterborne polyamides, latent curatives, tertiary amines, boron trifluoride-amine complexes, hydrazides, organic-acid hydrazides, dicyandiamide, etcetera), and an epoxy-modified dimerized fatty acid combined with an epoxy terminated polyurethane interpenetrating network.

In a preferred embodiment of the present invention, the curing agent is represented by at least one of the following tautomeric chemical structures:

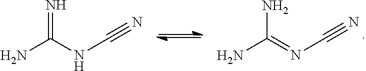 [SMILES: N#CNC(=N)N ; N#CN=C(N)N]

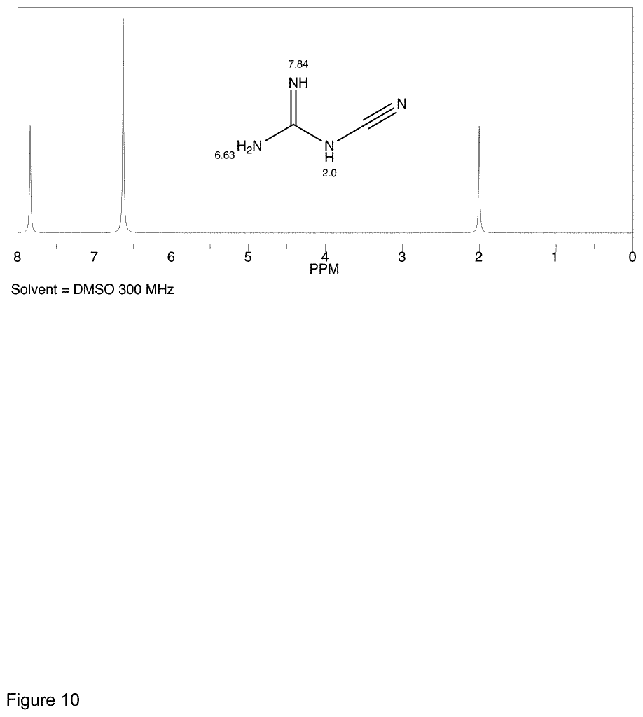

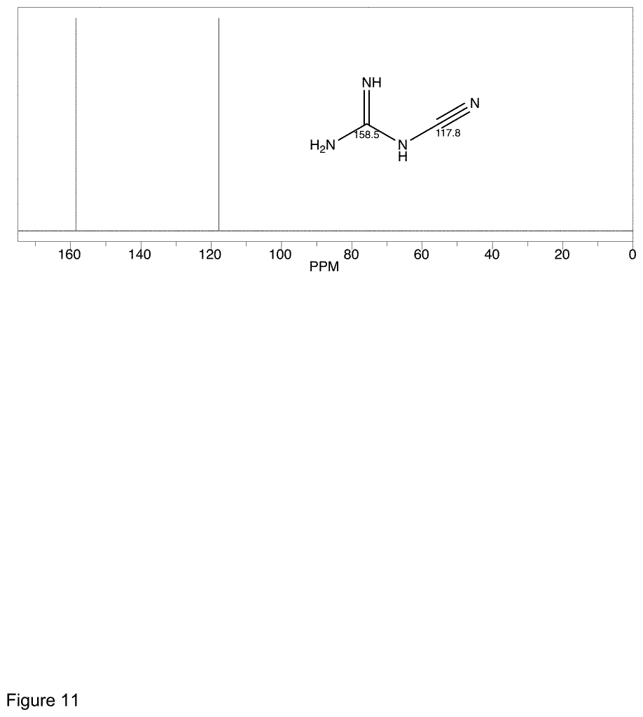

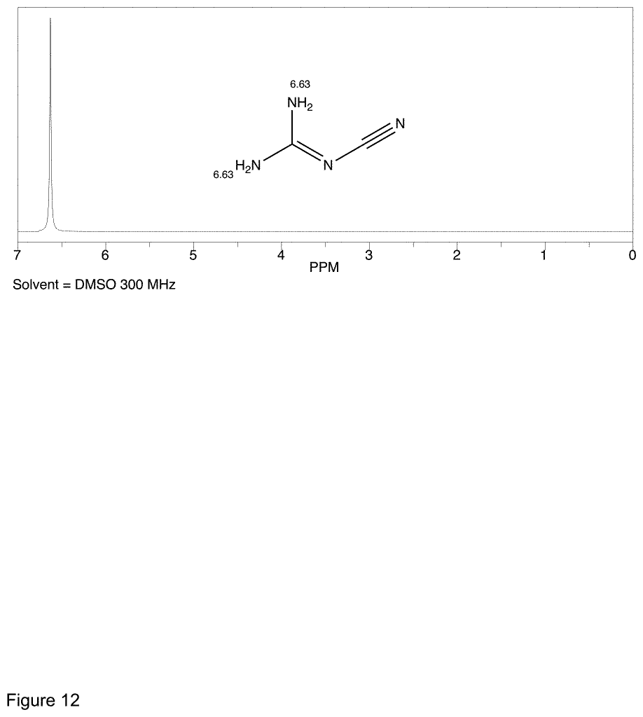

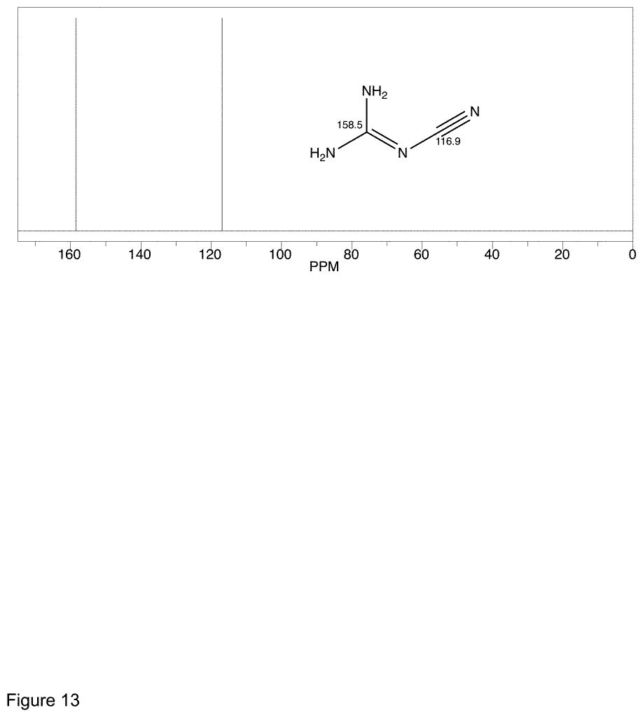

In this embodiment, the first tautomer of the curing agent generally comprises the ¹H-NMR spectrogram of FIG. 10 and/or the ¹³C-NMR spectrogram of FIG. 11, and the second tautomer of the curing agent generally comprises the ¹H-NMR spectrogram of FIG. 12 and/or the ¹³C-NMR spectrogram of FIG. 13.

In another preferred embodiment of the present invention, the curing agent is represented by the following chemical structure:

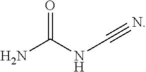

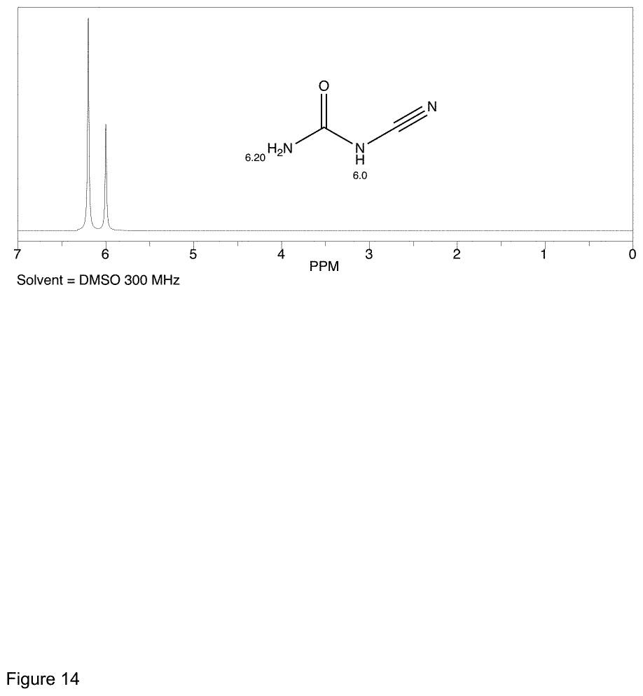

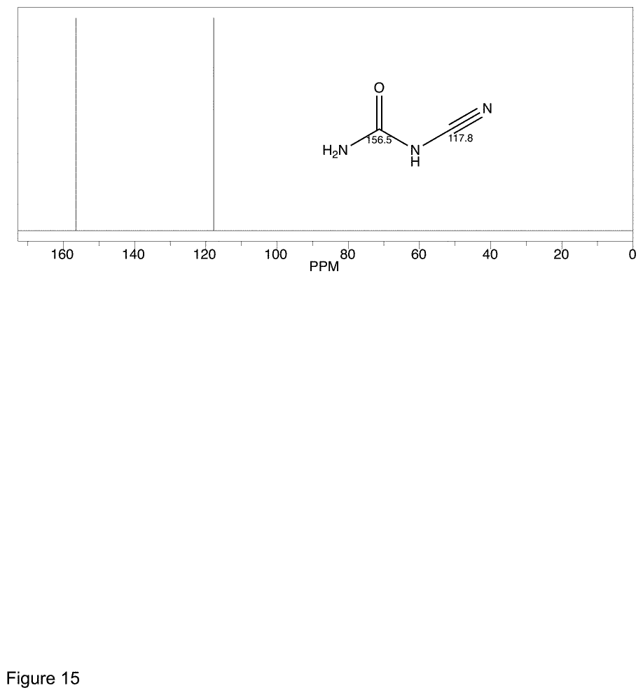

In this embodiment, the curing agent generally comprises the ¹H-NMR spectrogram of FIG. 14 and/or the ¹³C-NMR spectrogram of FIG. 15.

The above-identified curing agents and/or their precursors, are available from common commercial chemical vendors, such as Sigma-Aldrich Chemical Co., of St. Louis, Mo.

Suitable examples of epoxy-modified dimerized fatty acids include those represented by the following chemical structure:

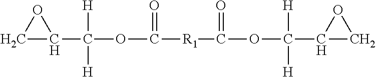

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 40 carbon atoms. In one embodiment, R₁ is tall oil based.

In another preferred embodiment of the present invention, the epoxy-modified dimerized fatty acid is represented by the following chemical structure:

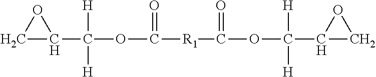

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 35 to approximately 40 carbon atoms.

In yet another preferred embodiment of the present invention, the epoxy-modified dimerized fatty acid is represented by the following chemical structure:

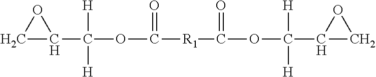

wherein R₁ is tall oil based (e.g., C₃₆, C₃₆H₇₂, etcetera).

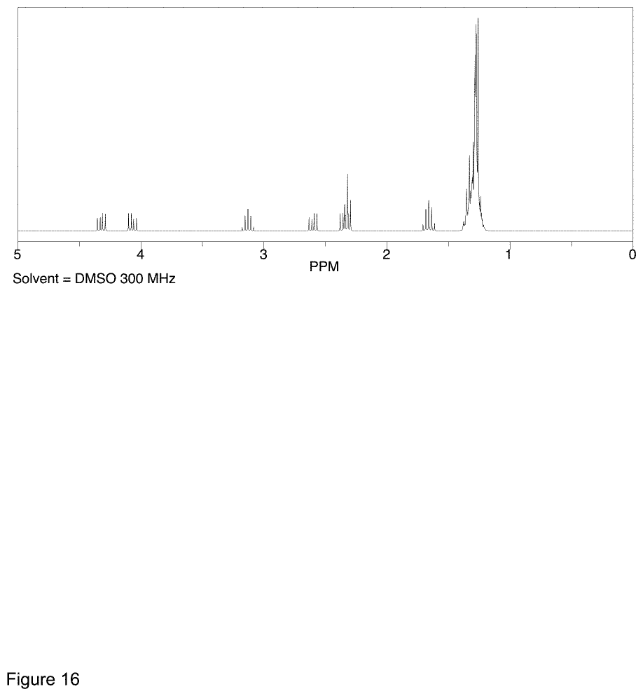

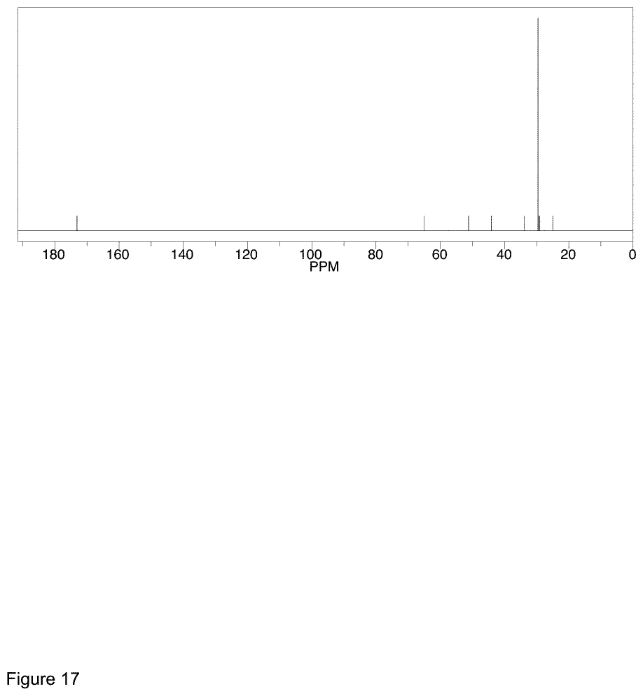

In this embodiment, the epoxy-modified dimerized fatty acid curing agent generally comprises the ¹H-NMR spectrogram of FIG. 16 and/or the ¹³C—NMR spectrogram of FIG. 17.

The above-identified epoxy-modified dimerized fatty acid and/or its precursors, are available from common commercial chemical vendors, such as Sigma-Aldrich Chemical Co., of St. Louis, Mo.

In accordance with the present invention, suitable examples of epoxy terminated polyurethane interpenetrating networks include those represented by the following chemical structure:

A₁-R₁A₂

wherein A₁ is represented by the following chemical structure:

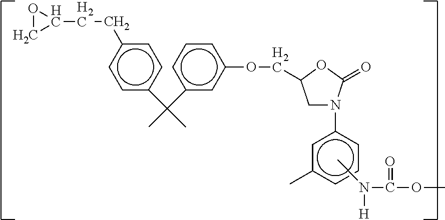

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 75 carbon atoms, an oligomer, and/or a polymer; and wherein A₂=A₁ and/or comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 35 carbon atoms, an oligomer, and/or a polymer.

In a preferred embodiment of the present invention, the epoxy terminated polyurethane interpenetrating network is represented by the following chemical structure:

A₁-R₁-A₂

wherein A₁ is represented by the following chemical structure:

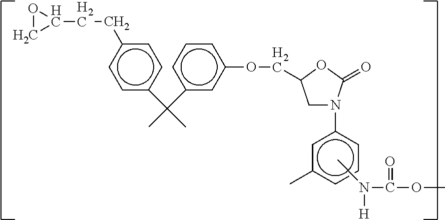

wherein R₁ comprises an alkyl, alkenyl, and/or alkynyl group containing approximately 1 to approximately 36 carbon atoms, an oligomer, and/or a urethane polymer; and wherein A₂=A₁.

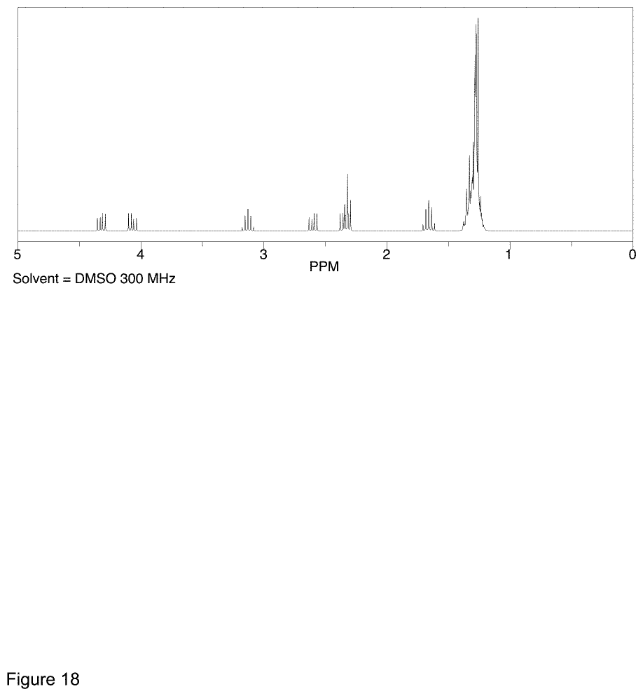

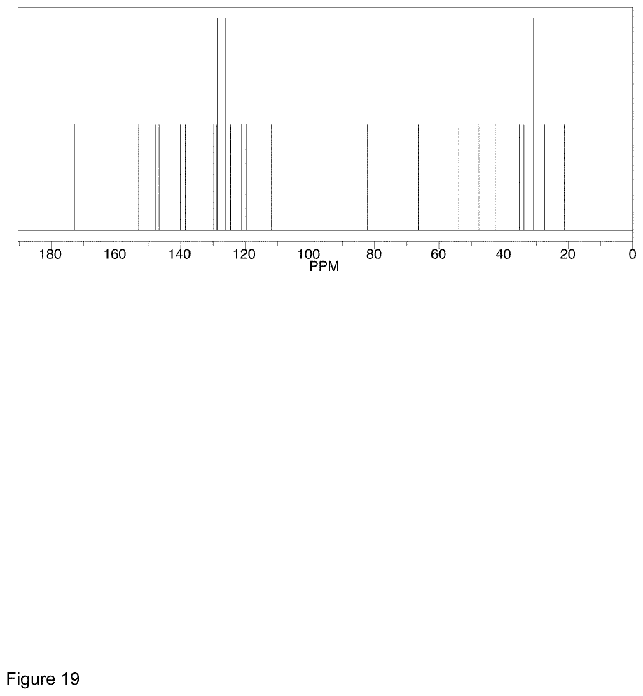

In this embodiment, A₁ generally comprises the ¹H-NMR spectrogram of FIG. 18 and/or the ¹³C-NMR spectrogram of FIG. 19.

The above-identified epoxy terminated polyurethane interpenetrating network and/or its precursors, are available from common commercial chemical vendors, such as Sigma-Aldrich Chemical Co., of St. Louis, Mo.

Additional interpenetrating polymer networks are also contemplated for use in accordance with the present invention, including, for example, those disclosed in U.S. Pat. No. 4,766,183 entitled “Thermosetting Composition for an Interpenetrating Polymer Network System,” U.S. Pat. No. 4,842,938 entitled “Metal Reinforcing Patch and Method for Reinforcing Metal,” U.S. Pat. No. 5,767,187 entitled “Interpenetrating Polymer Network Compositions,” U.S. Pat. No. 6,166,127 entitled “Interpenetrating Networks of Polymers,” U.S. Pat. No. 7,429,220 entitled “Golf Balls Containing Interpenetrating Polymer Networks,” and U.S. Pat. No. 7,790,288 entitled “Interpenetrating Polymer Network as Coating for Metal Substrate and Method Therefor”—which are hereby incorporated herein by reference in their entirety, including all references cited therein.

The invention is further described by the following examples.

### Cured Mechanical Properties

### Example/Test:

### 1. Lapshear Strength (MPa) (SAE J1523)

Material applied on oily substrate assembled as similar (1A) and dissimilar (1B) combination for 1″×0.5″, 0.01 bondline on 1″×3″ coupon. It is then baked at 171° C./10′ and 205° C./30′, then tested at room temperature (RT).

### 2. T-Peel Strength (N/mm) (ASTM D1876)

Material applied on oily substrate, assembled as similar (2A) and dissimilar (2B) combination for 1″×3″, 0.01″ bondline on 1″×′3″ coupon. It is then baked at 171° C./10′ and 205° C./30′, then tested at RT.

### 3. Wedge Impact Peel Strength (N/mm) (ISO 11343)

Material applied on oily substrate, assembled as similar (3A) and dissimilar (3B) combination for 20 mm×30 mm, 0.01″ bondline on 20 mm×90 mm coupon symmetric wedge. It is then baked at 171° C./10′ and 205° C./30′, then tested at RT.

### 4. Modulus of Elasticity (ASTM D638)

### 5. Elongation (ASTM D638)

### 6. Coefficient of Linear Thermal Expansion (CLTE) (ASTM E831-14)

### Substrate:

1. Electrogalvanized (0.7 mm)
2. Hot Dipped Galvanized (0.75 mm)
3. Aluminum (6022 Type) (0.9 mm)
4. Cold Rolled Steel (0.8 mm)
5. Aluminum (6016 Type) (1 mm)
Oil: Ferrocote 6130
Bake Cycle: 171° C./10′ (metal type)//205° C./30′ (metal type)

### Example 1A

### Lapshear Strength (MPa)—Similar Substrate Combination

1″×0.5″, 0.01″ bondline on 1″×3″ coupon

| | Low Bake | High Bake |
|---|---|---|
| Substrate | (171° C./10′) | (205° C./30′) |
| Electrogalvanized (0.7 mm) + | 16.88 | 15.01 |
| Electrogalvanized (0.7 mm) | 16.75 | 14.99 |
| | 16.82 | 15.00 |
| Hot Dipped Galvanized (0.75 mm) + | 15.82 | 15.71 |
| Hot Dipped Galvanized (0.75 mm) | 15.77 | 15.53 |
| | 15.79 | 15.62 |
| Aluminum (6022 Type) (0.9 mm) + | 17.64 | 17.30 |
| Aluminum (6022 Type) (0.9 mm) | 17.60 | 17.51 |
| | 17.62 | 17.40 |
| Cold Rolled Steel (0.8 mm) + | 22.90 | 19.72 |
| Cold Rolled Steel (0.8 mm) | 21.61 | 20.78 |
| | 22.25 | 20.25 |
| Aluminum (6016 Type) (1 mm) + | 16.33 | 18.11 |
| Aluminum (6016 Type) (1 mm) | 16.38 | 18.42 |
| | 16.36 | 18.27 |

### Example 2A

### T-Peel Strength (N/mm)—Similar Substrate Combination

1″×3″, 0.01″ bondline on 1″×4″ coupon

| | Low Bake | High Bake |
|---|---|---|
| Substrate | (171° C./10′) | (205° C./30′) |
| Electrogalvanized (0.7 mm) + | 12.26 | 10.21 |
| Electrogalvanized (0.7 mm) | 10.33 | 10.89 |
| | 11.29 | 10.55 |
| Hot Dipped Galvanized (0.75 mm) + | 11.02 | 10.85 |
| Hot Dipped Galvanized (0.75 mm) | 11.56 | 10.23 |
| | 11.29 | 10.54 |
| Aluminum (6022 Type) (0.9 mm) + | 11.41 | 11.13 |
| Aluminum (6022 Type) (0.9 mm) | 10.70 | 10.28 |
| | 11.05 | 10.70 |
| Cold Rolled Steel (0.8 mm) + | 13.05 | 14.20 |
| Cold Rolled Steel (0.8 mm) | 12.58 | 12.78 |
| | 12.81 | 13.49 |
| Aluminum (6016 Type) (1 mm) + | 11.28 | 10.03 |
| Aluminum (6016 Type) (1 mm) | 10.43 | 9.83 |
| | 10.86 | 9.93 |

### Example 3A

### Wedge Impact Strength (N/mm)—Similar Substrate Combination

20 mm×30 mm, 0.01″ bondline on 20 mm×90 mm coupon Test at RT

| | Low Bake | High Bake |
|---|---|---|
| Substrate | (171° C./10′) | (205° C./30′) |
| Hot Dipped Galvanized (0.75 mm) + | 33.58 | 41.03 |
| Hot Dipped Galvanized (0.75 mm) | 35.95 | 39.05 |
| | 34.76 | 40.04 |
| Aluminum (6022 Type) (0.9 mm) + | 32.60 | 33.76 |
| Aluminum (6022 Type) 0.9 mm) | 31.92 | 34.03 |
| | 32.26 | 33.89 |
| Cold Rolled Steel (0.8 mm) + | 35.58 | 32.18 |
| Cold Rolled Steel (0.8 mm) | 32.56 | 33.39 |
| | 34.21 | 32.79 |
| Electrogalvanized (0.7 mm) + | 35.85 | 30.81 |
| Electrogalvanized (0.7 mm) | 31.89 | 31.11 |
| | 33.87 | 30.96 |

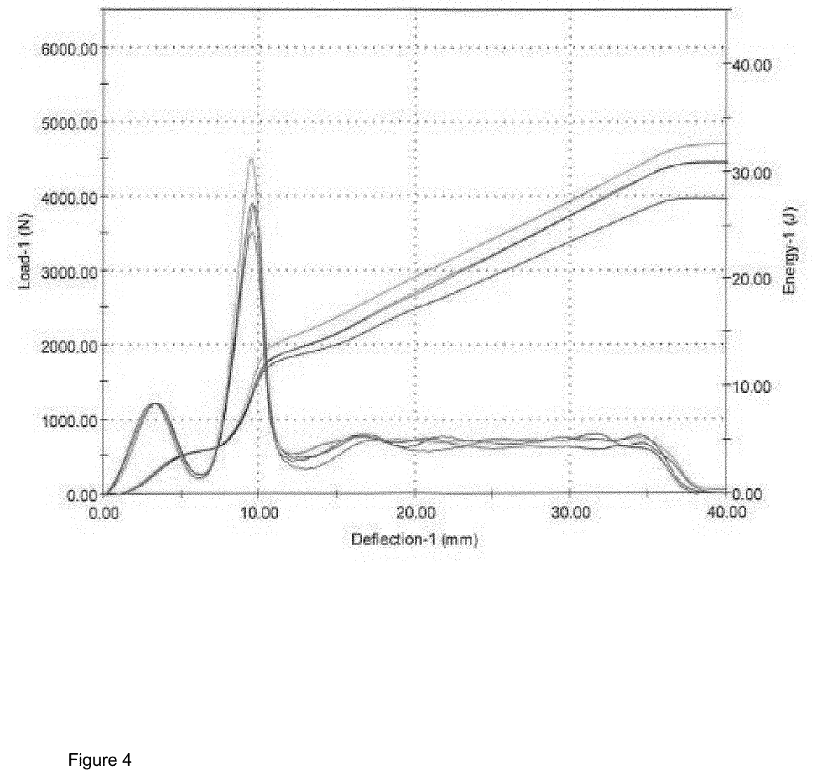

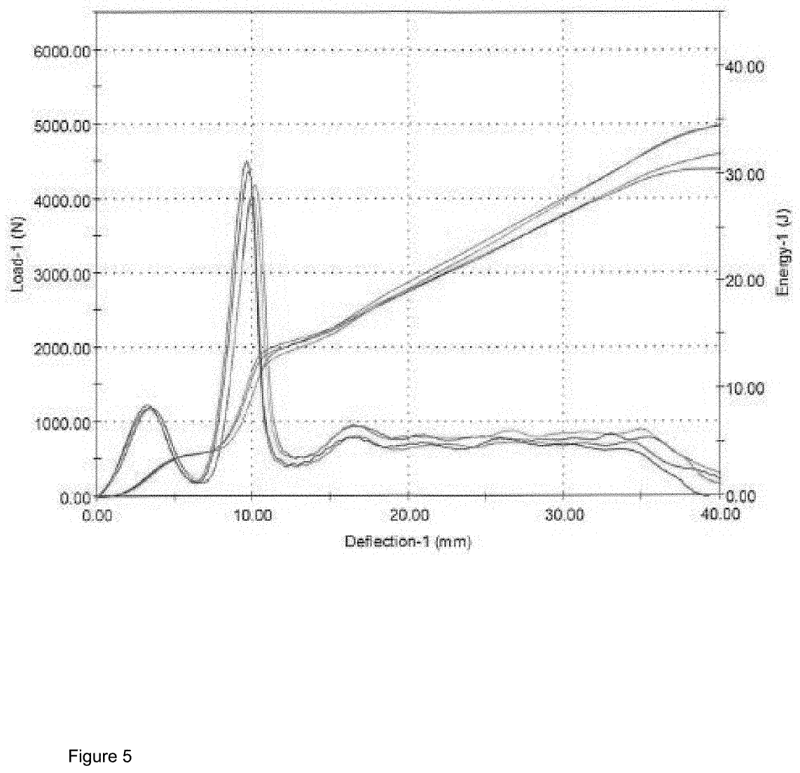

See FIGS. 4 and 5 for corresponding low and high bake two-dimensional graphs.

### Example 1B

### Lapshear Strength (MPa)—Dissimilar Substrate Combination

1″×0.5″, 0.01″ bondline on 1″×3″ coupon

| | Low Bake | High Bake |
|---|---|---|
| Substrate | (171° C./10′) | (205° C./30′) |
| Electrogalvanized (0.7 mm) + | 15.92 | 16.22 |
| Hot Dipped Galvanized (0.75 mm) | 16.02 | 16.37 |
| | 15.97 | 16.30 |
| Electrogalvanized (0.7 mm) + | 16.72 | 17.11 |
| Cold Rolled Steel (0.8 mm) | 16.97 | 16.82 |
| | 16.85 | 16.97 |
| Cold Rolled Steel (0.8 mm) + | 18.06 | 20.11 |
| Aluminum (6022 Type) (0.9 mm) | 17.66 | 19.82 |
| | 17.86 | 19.97 |
| Electrogalvanized (0.7 mm) + | 16.37 | 17.77 |
| Aluminum (6022 Type) (0.9 mm) | 16.01 | 17.01 |
| | 16.19 | 17.39 |
| Hot Dipped Galvanized (0.75 mm) + | 15.16 | 17.38 |
| Aluminum (6022 Type) (1 mm) | 16.22 | 16.92 |
| | 15.69 | 17.15 |

### Example 2B

### T-Peel Strength (N/mm)—Dissimilar Substrate Combination

1″×3″, 0.01″ bondline on 1″×4″ coupon

| | Low Bake | High Bake |
|---|---|---|
| Substrate | (171° C./10′) | (205° C./30′) |
| Electrogalvanized (0.7 mm) + | 12.56 | 9.35 |
| Hot Dipped Galvanized (0.75 mm) | 12.66 | 9.30 |
| | 12.61 | 9.33 |
| Electrogalvanized (0.7 mm) + | 10.86 | 9.89 |
| Cold Rolled Steel (0.8 mm) | 10.85 | 10.25 |
| | 10.85 | 10.07 |
| Cold Rolled Steel (0.8 mm) + | 11.00 | 9.40 |
| Aluminum (6022 Type) (0.9 mm) | 11.04 | 9.25 |
| | 11.02 | 9.33 |
| Electrogalvanized (0.7 mm) + | 11.75 | 9.83 |
| Aluminum (6022 Type) (0.9 mm) | 11.90 | 9.91 |
| | 11.83 | 9.87 |
| Hot Dipped Galvanized (0.75 mm) + | 11.83 | 9.38 |
| Aluminum (6022 Type) (1 mm) | 11.67 | 9.43 |
| | 11.75 | 9.41 |

### Example 3B

### Wedge Impact Strength (N/mm)—Dissimilar Substrate Combination

20 mm×30 mm, 0.01″ bondline on 20 mm×90 mm coupon

Test at RT

| | Low Bake | High Bake |
|---|---|---|
| Substrate | (171° C./10′) | (205° C./30′) |
| Electrogalvanized (0.7 mm) + | 31.45 | 28.91 |
| Aluminum (6022 Type) (0.9 mm) | 32.92 | 29.93 |
| | 32.19 | 29.42 |
| Hot Dipped Galvanized (0.75 mm) + | 30.69 | 27.62 |
| Aluminum (6022 Type) (1 mm) | 31.31 | 27.82 |
| | 31.00 | 27.72 |
| Cold Rolled Steel (0.8 mm) + | 29.55 | 28.28 |
| Aluminum (6022 Type) (0.9 mm) | 29.57 | 29.01 |
| | 29.56 | 28.65 |

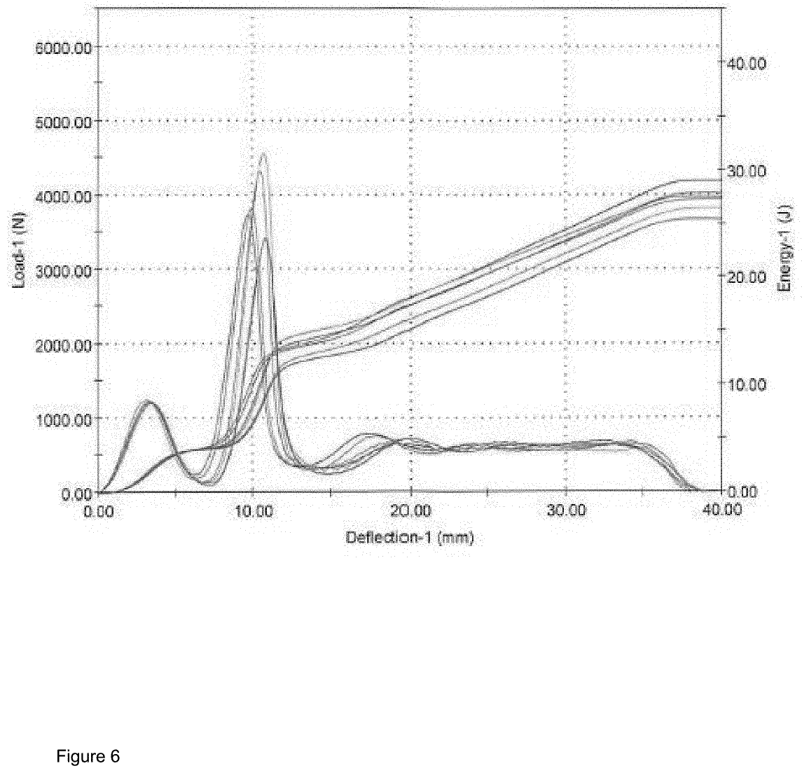

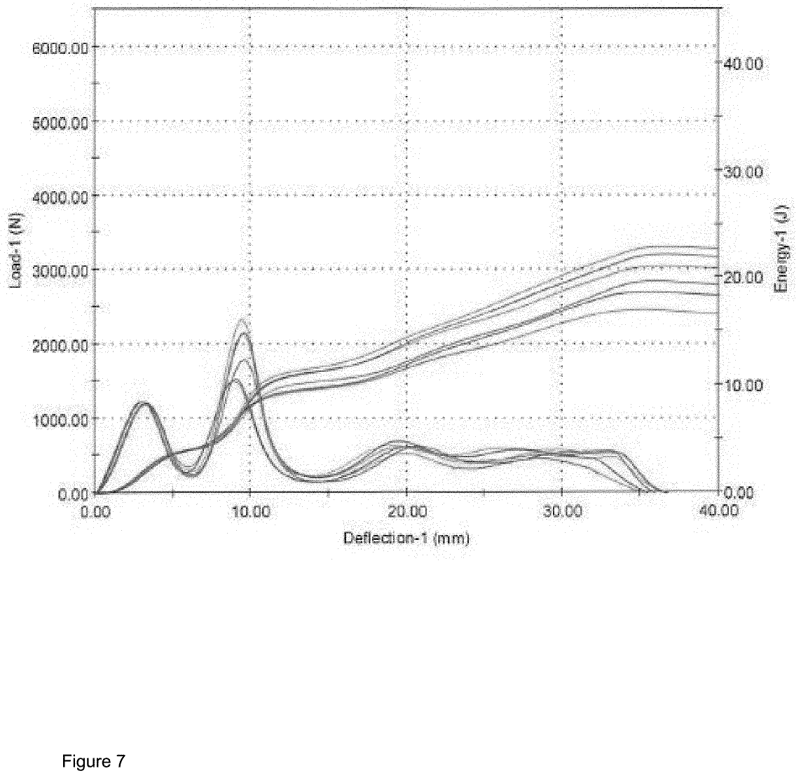

See FIGS. 6 and 7 for corresponding low and high bake two-dimensional graphs.

### Examples 4 & 5

### Modulus of Elasticity, GPa & Elongation (%)

| Modulus of Elasticity, | |
|---|---|
| GPa | Elongation, (%) |
| 0.458 | 53.23 |
| 0.416 | 51.45 |
| 0.437 | 52.34 |

### Example 6

### Coefficient of Linear Thermal Expansion (CLTE)

Results
To measure the coefficient of linear thermal expansion (CLTE) of sample
by TMA per ASTM E831-14 as a guide. The sample was punched into a
cylindrical shape and tested with a TMA Q400, TA instruments,
equipped with an expansion probe (2.54 mm in diameter). A force of
20 mN was applied to the sample while heating the sample with a heating
rate of 5.00° C./min in N2. TMA curves are shown in FIG. 1.
Conclusion: The average CLTE (μm/(m · ° C.) values
calculated within a certain temperature range (brackets) are as follows.

| 1^{st} heating | | 2^{nd} heating | |
|---|---|---|---|
| CLTE-1 | CLTE-2 | CLTE-1 | CLTE-2 |
| 102.6 | 223.8 | 99.40 | 219.2 |
| (−60 to −10° C.) | (20 to 160° C.) | (−60 to −10° C.) | (20 to 160° C.) |

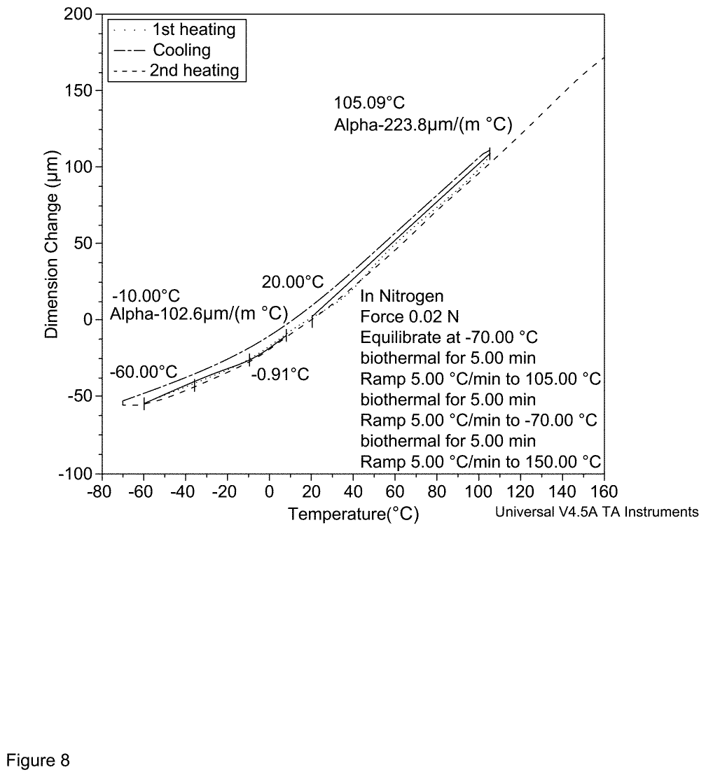

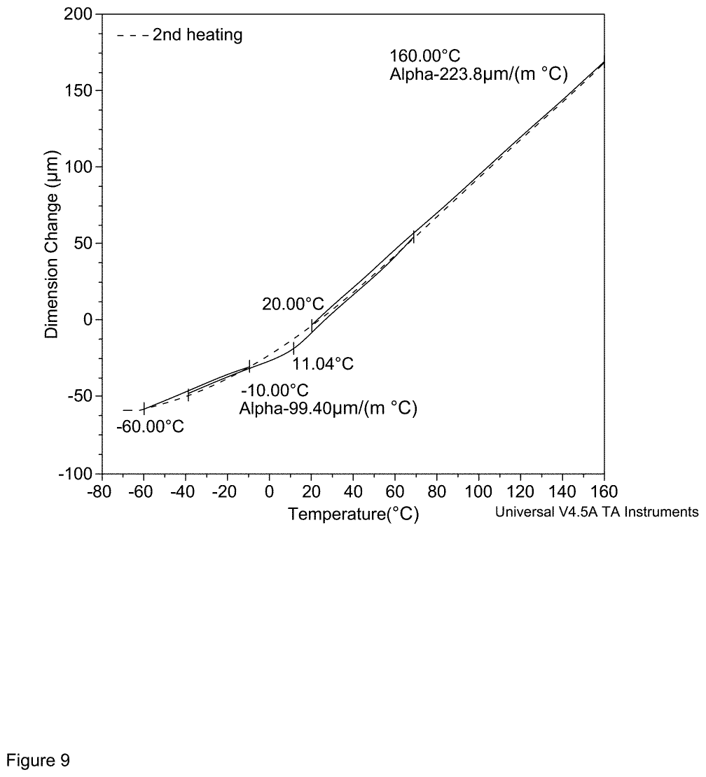

See FIGS. 8 and 9 for corresponding CLTE two-dimensional graphs.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A substrate assembly, comprising:
a first substrate;
a second substrate; and
a thermosetting adhesive associated with at least a portion of the first and second substrates:
wherein the thermosetting adhesive has been formulated based on epoxy-modified dimerized fatty acids combined with an epoxy terminated polyurethane interpenetrating network (IPN) and a diglycidylether of bisphenol-A;
wherein the thermosetting adhesive exhibits extremely low modulus and high elongation; and
wherein the thermosetting adhesive absorbs energy produced during distortion of similar and/or dissimilar metal which occurs during an e-coat oven curing process and/or any dynamic climate condition.

2. A substrate assembly, comprising:
a first substrate;
a second substrate; and
a thermosetting adhesive associated with at least a portion of the first and second substrates, wherein the thermosetting adhesive includes a curing agent, and an epoxy-modified dimerized fatty acid combined with an epoxy terminated polyurethane interpenetrating network.

3. The substrate assembly according to claim 2, wherein the first and second substrates comprise similar metals.

4. The substrate assembly according to claim 2, wherein the first and second substrates comprise dissimilar metals.

5. The substrate assembly according to claim 2, wherein the first substrate comprises at least one of steel, steel electrogalvanized with zinc, steel hot dipped galvanized with zinc, aluminum, metal alloys, d-block metals, and combinations thereof.

6. The substrate assembly according to claim 2, wherein the second substrate comprises at least one of steel, steel electrogalvanized with zinc, steel hot dipped galvanized with zinc, aluminum, metal alloys, d-block metals, and combinations thereof.

7. The substrate assembly according to claim 2, wherein the first substrate comprises aluminum and the second substrate comprises steel.

8. The substrate assembly according to claim 2, wherein the curing agent comprises at least one of a boron trifluoride-amine complex, an organic-acid hydrazide, and dicyandiamide.

9. The substrate assembly according to claim 2, wherein the curing agent is represented by at least one of the following tautomeric chemical structures:

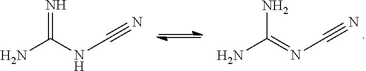 [SMILES: N#CNC(=N)N ; N#CN=C(N)N]

10. The substrate assembly according to claim 2, wherein the epoxy-modified dimerized fatty acid is represented by the following chemical structure: 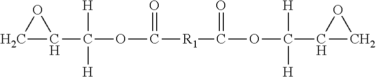
wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 40 carbon atoms.

11. The substrate assembly according to claim 2, wherein the epoxy-modified dimerized fatty acid is represented by the following chemical structure: 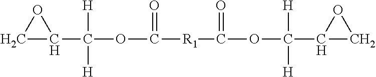
wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 35 to approximately 40 carbon atoms.

12. The substrate assembly according to claim 2, wherein the epoxy-modified dimerized fatty acid is represented by the following chemical structure: 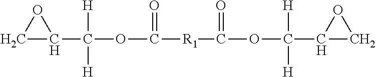
wherein R₁ is tall oil based.

13. The substrate assembly according to claim 2, wherein the epoxy terminated polyurethane interpenetrating network is represented by the following chemical structure:
A₁-R₁-A₂
wherein A₁ is represented by the following chemical structure: 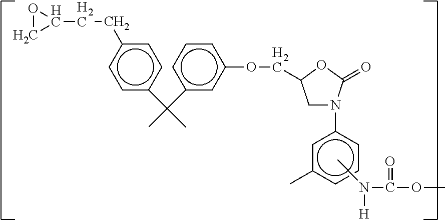
wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 75 carbon atoms, an oligomer, and/or a polymer; and wherein A₂=A₁ and/or comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 35 carbon atoms, an oligomer, and/or a polymer.

14. The substrate assembly according to claim 2, wherein the epoxy terminated polyurethane interpenetrating network is represented by the following chemical structure:
A₁-R₁-A₂
wherein A₁ is represented by the following chemical structure: 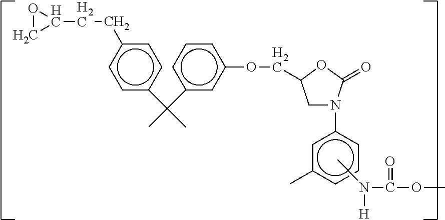
wherein R₁ comprises an alkyl, alkenyl, and/or alkynyl group containing approximately 1 to approximately 36 carbon atoms, an oligomer, and/or a urethane polymer; and wherein A₂=A₁.

15. A substrate assembly, comprising:
a first substrate;
a second substrate;
a thermosetting adhesive associated with at least a portion of the first and second substrates, wherein the thermosetting adhesive includes a curing agent, and an epoxy-modified dimerized fatty acid combined with an epoxy terminated polyurethane interpenetrating network;
wherein the curing agent is represented by at least one of the following tautomeric chemical structures: 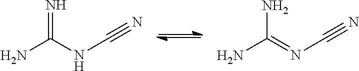 [SMILES: N#CNC(=N)N ; N#CN=C(N)N]
wherein the epoxy-modified dimerized fatty acid is represented by the following chemical structure: 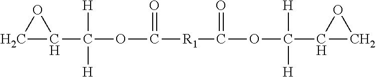
wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 35 to approximately 40 carbon atoms; and
wherein the epoxy terminated polyurethane interpenetrating network is represented by the following chemical structure:
A₁-R₁-A₂
wherein A₁ is represented by the following chemical structure: 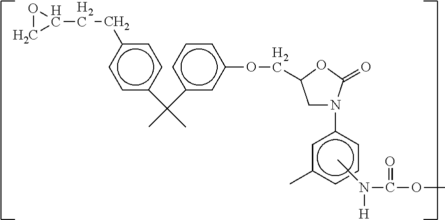
wherein R₁ comprises an alkyl, alkenyl, and/or alkynyl group containing approximately 1 to approximately 36 carbon atoms, an oligomer, and/or a urethane polymer; and wherein A₂=A₁.

16. The substrate assembly according to claim 15, wherein the first substrate comprises aluminum and the second substrate comprises steel.
